(19) United States
(12) Patent Application Publication
(10) Pub. No.: US 2026/0338223 A1
(43) Pub. Date: Oct. 29, 2026

(54) Power Transmission Shaft and Propeller Shaft

(71) Applicant: Hitachi Astemo, Ltd., Hitachinaka-shi, Ibaraki (JP)

(72) Inventors: Yasushi AKITA, Hitachinaka-shi, Ibaraki (JP); Sha LI, Hitachinaka-shi, Ibaraki (JP); Kento HARUNA, Hitachinaka-shi, Ibaraki (JP)

(21) Appl. No.: 19/111,539

(22) PCT Filed: Aug. 1, 2023
(86) PCT No.: PCT/JP2023/028042

§ 371 Date: Mar. 13, 2025

(30) Foreign Application Priority Data
Sep. 14, 2022 (JP) 2022-146313

(51) Int. Cl. F16C 3/02; B60K 17/22

(52) U.S. Cl. CPC F16C 3/026; B60K 17/22; F16C 3/023; F16C 2226/80; F16C 2326/06

(57) ABSTRACT

A propeller shaft (PS1) as a propeller shaft according to the present invention is configured so that a first collapse length (S1) of a first joint member (J1) bending based on a first bending load is set to be longer than a second collapse length (S2) of a second joint member (J2) bending based on a second bending load that is greater than the first bending load. With this setting, even when an axial direction load acts on the propeller shaft (PS1) from a first end portion (11) side, or from a second end portion (12) side, or from both sides of the first end portion (11) and the second end portion (12), the second joint member (J2) can be smoothly inserted into an inside of a tube (1). It is therefore possible to stabilize collision performance of the propeller shaft (PS1).

### TECHNICAL FIELD

The present invention relates to a power transmission shaft and a propeller shaft.

### BACKGROUND ART

A conventional propeller shaft as a power transmission shaft disclosed in, for instance, the following Patent Document 1 has been known.

When describing an outline of this propeller shaft as the power transmission shaft briefly, a first shaft portion connected to a constant-velocity joint that is relatively easy to bend is press-fitted into a first end portion of a tube, and a second shaft portion connected to a rubber coupling that is relatively hard to bend is press-fitted into a second end portion of the tube.

### CITATION LIST

### Patent Document

Patent Document 1: Japanese Unexamined Patent Application Publication No. JP2021-138203

### SUMMARY OF THE INVENTION

### Technical Problem

In the case of above conventional propeller shaft, however, a relationship of length between a length (a first collapse length) by which the first shaft portion connected to the constant-velocity joint that is easy to bend penetrates into an inside of the tube and a length (a second collapse length) by which the second shaft portion connected to the rubber coupling that is hard to bend penetrates into the inside of the tube is not taken into consideration at all. Therefore, there is room for improvement in that collision performance of the propeller shaft becomes unstable.

The present invention was made in view of the above technical problem of the conventional propeller shaft. An object of the present invention is therefore to provide a power transmission shaft and a propeller shaft that are capable of improving stability of the collision performance.

### Solution to Problem

According to one aspect of the present invention, a first collapse length by which a first shaft portion of a first joint member that can bend by a first bending load is inserted into an inner peripheral portion of a tube is set to be longer than a second collapse length by which a second shaft portion of a second joint member having a bending load that is greater than the first bending load is inserted into the inner peripheral portion of the tube.

### Effects of Invention

According to the present invention, it is possible to improve the stability of the collision performance.

### BRIEF DESCRIPTION OF THE DRAWINGS

FIG. 1 is a layout drawing showing an arrangement of a power transmission shaft (a propeller shaft) according to the present invention in a vehicle.

FIG. 2 is a longitudinal cross section of the entire power transmission shaft (the entire propeller shaft) according to a first embodiment of the present invention.

FIGS. 3A to 3C are longitudinal cross sections of the power transmission shaft (the propeller shaft) shown in FIG. 2, showing conditions of the power transmission shaft (the propeller shaft) to which a collision load is input from a vehicle front side. FIG. 3A shows a condition of the power transmission shaft (the propeller shaft) in which the collapse has not occurred. FIG. 3B shows a condition of the power transmission shaft (the propeller shaft) in which the collapse has occurred at a first end portion side of a tube. FIG. 3C shows a condition of the power transmission shaft (the propeller shaft) in which the collapse has occurred at a second end portion side of the tube.

FIGS. 4A to 4C are longitudinal cross sections of the power transmission shaft (the propeller shaft) shown in FIG. 2, showing conditions of the power transmission shaft (the propeller shaft) to which the collision load is input from a vehicle rear side. FIG. 4A shows a condition of the power transmission shaft (the propeller shaft) in which the collapse has not occurred. FIG. 4B shows a condition of the power transmission shaft (the propeller shaft) in which the collapse has occurred at the second end portion side of the tube. FIG. 4C shows a condition of the power transmission shaft (the propeller shaft) in which the collapse has occurred at the first end portion side of the tube.

FIGS. 5A and 5B are longitudinal cross sections of the power transmission shaft (the propeller shaft) shown in FIG. 2, showing conditions of the power transmission shaft (the propeller shaft) to which the collision load is input from the vehicle front and rear sides. FIG. 5A shows a condition of the power transmission shaft (the propeller shaft) in which the collapse has not occurred. FIG. 5B shows a condition of the power transmission shaft (the propeller shaft) in which the collapse has occurred at the first end portion side and the second end portion side of the tube.

FIGS. 6A and 6B are schematic diagrams for explaining working and effect of the present invention when the collapse has occurred from the first end portion side. FIG. 6A shows a state of the collapse of the power transmission shaft (the propeller shaft) according to the present invention. FIG. 6B shows a state of the collapse of a conventional power transmission shaft (a conventional propeller shaft).

FIGS. 7A and 7B are schematic diagrams for explaining working and effect of the present invention when the collapse has occurred from the second end portion side. FIG. 7A shows a state of the collapse of the power transmission shaft (the propeller shaft) according to the present invention. FIG. 7B shows a state of the collapse of the conventional power transmission shaft (the conventional propeller shaft).

FIGS. 8A and 8B are schematic diagrams for explaining working and effect of the present invention when the collapse has occurred from both of the first end portion side and the second end portion side. FIG. 8A shows a state of the collapse of the power transmission shaft (the propeller shaft) according to the present invention. FIG. 8B shows a state of the collapse of the conventional power transmission shaft (the conventional propeller shaft).

FIG. 9 is a longitudinal cross section of the entire power transmission shaft (the entire propeller shaft) according to a second embodiment of the present invention.

FIG. 10 is a longitudinal cross section of the entire power transmission shaft (the entire propeller shaft) according to a third embodiment of the present invention.

FIG. 11 is a layout drawing showing another example of the arrangement of the power transmission shaft (the propeller shaft) according to the present invention in the vehicle.

### EMBODIMENTS FOR CARRYING OUT THE INVENTION

Embodiments of a power transmission shaft (a propeller shaft) according to the present invention will be described below with reference to the drawings. In the following embodiments, examples in which the power transmission shaft (the propeller shaft) is applied as a propeller shaft for a vehicle, as in the conventional case, will be described.

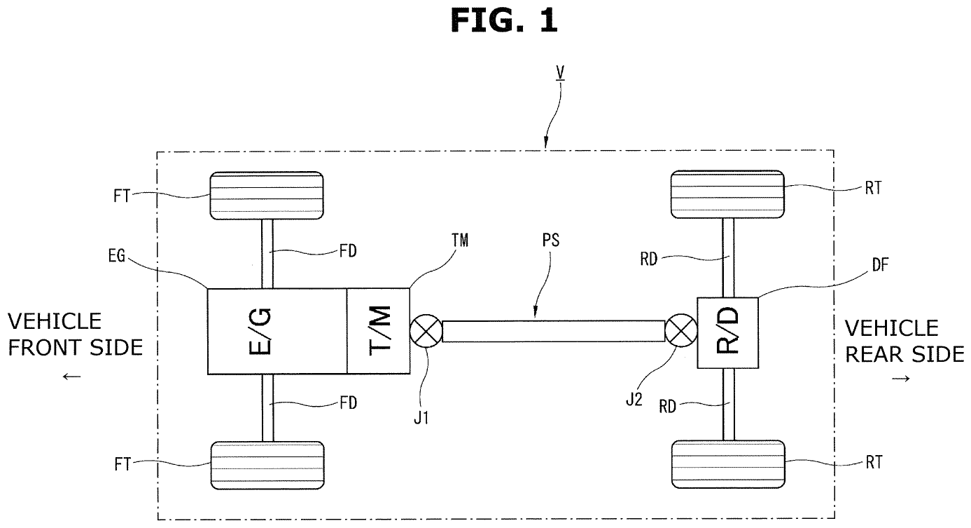

FIG. 1 is a layout drawing showing an arrangement of a power transmission shaft (a propeller shaft) according to the present invention in a vehicle.

As illustrated in FIG. 1, a vehicle V is a so-called FR (front-engine, rear-drive) vehicle. An engine EG and a transmission TM as a first power transmission device (a transmission device) that transmits a driving force of the engine EG are disposed on a front axle FD that connects front wheels FT. On the other hand, a differential gear DF as a second power transmission device (a differential device) that transmits power to a rear axle RD is disposed at a middle portion of the rear axle RD that connects rear wheels RT. Then, the transmission TM and the differential gear DF are connected so as to be able to transmit power through a propeller shaft PS as the power transmission shaft.

### First Embodiment

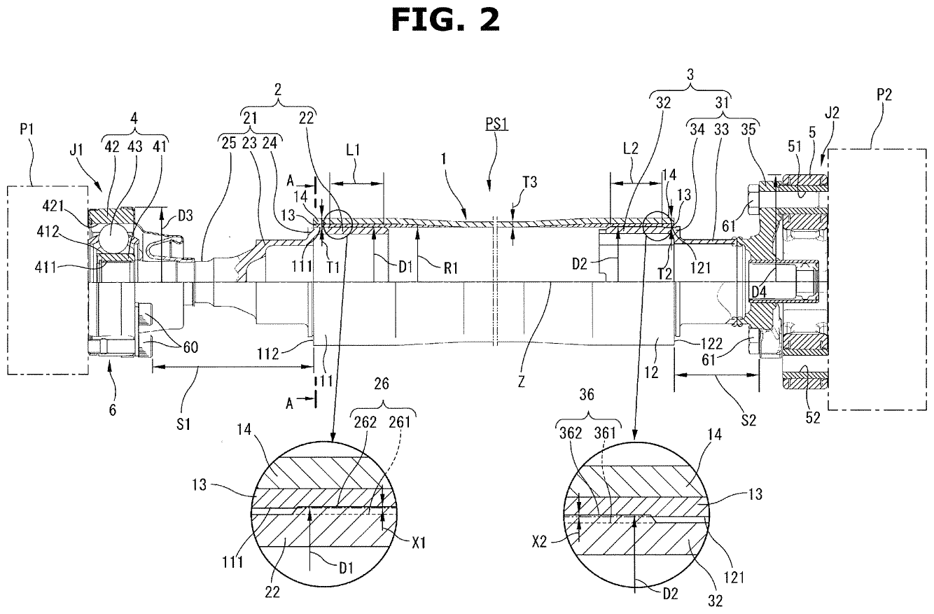

FIGS. 2 to 8 illustrate a first embodiment of the power transmission shaft according to the present invention. In the following description of the present embodiment, for the sake of convenience, a left side in FIG. 2 is referred to as a “front”, and a right side is referred to as a “rear”.

Further, a direction along a rotation axis Z in FIG. 2 is referred to as an “axial direction”, a direction orthogonal to the rotation axis Z is referred to as a “radial direction”, and a direction of rotation about the rotation axis Z is referred to as a “circumferential direction”.

### Configuration of Propeller Shaft

FIG. 2 shows an entire propeller shaft PS1 according to the first embodiment of the present invention. FIG. 2 is a longitudinal cross section of the propeller shaft PS1, cut along the direction of the rotation axis Z.

As illustrated in FIG. 2, the propeller shaft PS1 is disposed between a first power transmission device P1 located at a vehicle front side and a second power transmission device P2 located at a vehicle rear side. In the present embodiment, the first power transmission device P1 corresponds to the transmission TM as the transmission device, and the second power transmission device P2 corresponds to the differential gear DF as the differential device.

That is, the propeller shaft PS1 according to the present embodiment is a so-called one-piece structure propeller shaft, and a front end side of the propeller shaft PS1 is connected to the first power transmission device P1 through a first joint member J1, and a rear end side of the propeller shaft PS1 is connected to the second power transmission device P2 through a second joint member J2. That is, the propeller shaft PS1 has a tube 1 formed into a substantially cylindrical tubular shape, the first joint member J1 inserted into a first end portion 11 that is a front end portion of the tube 1 and serving to connect to the first power transmission device P1, and the second joint member J2 inserted into a second end portion 12 that is a rear end portion of the tube 1 and serving to connect to the second power transmission device P2.

The tube 1 is made of a carbon fiber reinforced resin material (carbon fiber reinforced plastic) (a so-called CFRP) by solidifying carbon fiber with resin, and formed into the cylindrical tubular shape having a constant inside diameter R1 in the axial direction. Further, the tube 1 is formed so that thicknesses T1 and T2 of the first end portion 11 and the second end portion 12 of the tube 1 are thicker than a thickness T3 of a normal portion (an axial direction middle portion) of the tube 1. More specifically, the tube 1 is integrally formed by laminating the carbon fiber reinforced resin material (CFRP) in the radial direction, and has at least two inner and outer layers of an inner peripheral layer 13 and an outer peripheral layer 14.

It is noted that in the present embodiment, although an example in which the tube 1 is made of the carbon fiber reinforced resin material (CFRP) is described, the tube 1 could be made of a fiber reinforced resin (fiber reinforced plastic) formed by solidifying fiber with resin, or may be made of e.g. a metal material. Further, in the case where the tube 1 is made of the fiber reinforced resin, in addition to the carbon fiber reinforced resin material (CFRP), the tube 1 could be made of e.g. a glass fiber reinforced resin (glass fiber reinforced plastic) (FRP) by solidifying glass fiber with resin.

The first joint member J1 has a first shaft portion 2 inserted into an inner peripheral portion 111 of the first end portion 11 of the tube 1, and a first joint portion 4 connecting the first shaft portion 2 and the first power transmission device P1. The first shaft portion 2 and the first joint portion 4 are fixed so as to be able to integrally rotate, and integrally formed as the first joint member J1.

The second joint member J2 has a second shaft portion 3 inserted into an inner peripheral portion 121 of the second end portion 12 of the tube 1, and a second joint portion 5 connecting the second shaft portion 3 and the second power transmission device P2. The second shaft portion 3 and the second joint portion 5 are fixed so as to be able to integrally rotate, and integrally formed as the second joint member J2.

The first shaft portion 2 has a first connecting base portion 21 exposed from the first end portion 11 of the tube 1 and connected to the first joint portion 4, and a first inserting portion 22 extending in the axial direction from a rear end portion of the first connecting base portion 21 and inserted into the inner peripheral portion 111 of the first end portion 11 of the tube 1. The first connecting base portion 21 and the first inserting portion 22 are formed integrally with each other with a metal material.

The first connecting base portion 21 has a first base portion 23, a first insertion-side connecting portion 24 formed into a step shape whose diameter is widened from a rear end portion of the first base portion 23 and connecting to the first inserting portion 22, and a first joint-side connecting portion 25 formed into a step shape whose diameter is reduced from a front end portion of the first base portion 23 and connecting to the first joint portion 4. Here, the first connecting base portion 21 and the first joint portion 4 form a first body portion of the present invention.

The first inserting portion 22 is inserted into the inner peripheral portion 111 of the first end portion 11 of the tube 1 through a predetermined engagement means (serrations in the present embodiment), and is fixed to the tube 1 so as to be able to rotate integrally with the tube 1. More specifically, a first serration part 26 that can be serration-connected to the tube 1 is formed throughout an almost entire area in the axial direction on an outer peripheral side of the first inserting portion 22.

The first serration part 26 is formed so that grooves 261 recessed inward in the radial direction are formed so as to extend in a direction parallel to the rotation axis Z, and an outside diameter D1 of each tooth tip 262 is set to be slightly larger than the inside diameter R1 of the tube 1. That is, the first inserting portion 22 is press-fitted into an inside of the first end portion 11 of the tube 1, and each tooth tip 262 bites into an inner peripheral surface of the tube 1, then the first serration part 26 makes the first inserting portion 22 engage with the tube 1 so as to be able to integrally rotate with the tube 1. With this, the first inserting portion 22 is supported in a fixed state at the inner peripheral portion 111 of the first end portion 11 of the tube 1 through the first serration part 26.

Here, a first collision load F1 as a holding load, which releases the fixed state between the first inserting portion 22 and the tube 1 and causes the first inserting portion 22 to start moving from the first end portion 11 toward the second end portion 12 at the inner peripheral portion of the tube 1, is set between the first serration part 26 and the tube 1. It is noted that the first collision load F1 can be set based on an arbitrary engaging element such as a biting length L1 of the first serration part 26 engaging with (biting into) the inner peripheral portion 111 of the first end portion 11 of the tube 1 and a biting amount X1.

The first joint portion 4 is formed by a universal joint (for instance, a constant-velocity joint in the present embodiment). The first joint portion 4 is provided at an opposite side to the tube 1 in the axial direction with respect to the first shaft portion 2. The first joint portion 4 has a substantially cylindrical inner ring member 41 fixed to an outer peripheral surface of the first joint-side connecting portion 25 of the first shaft portion 2, a substantially cylindrical outer ring member 42 arranged at an outer peripheral side of the inner ring member 41 so as to face the inner ring member 41, and a plurality of balls 43 as rolling elements provided so as to be able to roll between the outer ring member 42 and the inner ring member 41.

Further, the first joint portion 4 is formed so that an outside diameter D3 of the outer ring member 42 is set to be larger than an outside diameter D1 of the first inserting portion 22. More specifically, the first joint portion 4 is formed so that when the first shaft portion 2 penetrates into the inside of the tube 1 upon collision of the vehicle at the front side, each head portion 60 of bolts 6, which are screwed into the first joint portion 4 from the tube 1 side and fastened to the first power transmission device P1, comes into contact with an end surface (a first end surface 112), located at the first end portion 11 side, of the tube 1.

Here, in the present embodiment, a first collapse length S1 by which the first shaft portion 2 penetrates into the inner peripheral portion 111 of the first end portion 11 of the tube 1 upon occurrence of an after-described collapse is set by a distance between the first end surface 112 of the tube 1 and the head portion 60 of the bolt 6. The first collapse length S1 is set to be longer than an after-mentioned second collapse length S2. More specifically, the first collapse length S1 is set to approximately twice the second collapse length S2. It is noted that the first collapse length S1 could be adjusted by an axial direction size (length) of the first connecting base portion 21, or may be adjusted by an axial direction size (length) of the head portion 60 of the bolt 6.

At an inner peripheral side of the inner ring member 41, a substantially circular shaft penetration hole 411, which the first joint-side connecting portion 25 penetrates, penetrates the inner ring member 41 along the axial direction. That is, the first joint-side connecting portion 25 is press-fitted into the shaft penetration hole 411 throughout an almost entire axial area of the shaft penetration hole 411, and the first joint-side connecting portion 25 and the inner ring member 41 are fixed so as to be able to integrally rotate.

Further, inner ring-side axial direction grooves 412 in which the balls 43 can roll are formed along the axial direction at the outer peripheral side of the inner ring member 41. That is, the balls 43 roll between the inner ring-side axial direction grooves 412 and after-mentioned outer ring-side axial direction grooves 421, thereby allowing relative axial movement of the inner ring member 41 and the outer ring member 42, also, the balls 43 engage with the inner ring-side axial direction grooves 412 and the outer ring-side axial direction grooves 421, thereby restricting relative circumferential movement of the inner ring member 41 and the outer ring member 42.

The outer ring member 42 is fixed to the first power transmission device P1 so as to be able to integrally rotate with the first power transmission device P1 with the plurality of bolts 6 penetrating the outer ring member 42 in the axial direction. As mentioned above, the outer ring-side axial direction grooves 421 in which the balls 43 can roll are formed along the axial direction at an inner peripheral side of the outer ring member 42. That is, the balls 43 roll between the outer ring-side axial direction grooves 421 and the inner ring-side axial direction grooves 412, thereby allowing relative axial movement of the outer ring member 42 and the inner ring member 41, also, the balls 43 engage with the outer ring-side axial direction grooves 421 and the inner ring-side axial direction grooves 412, thereby restricting relative circumferential movement of the outer ring member 42 and the inner ring member 41.

With this configuration, the first power transmission device P1 and the outer ring member 42 integrally rotate, thereby transmitting rotation torque output from the first power transmission device P1 to the inner ring member 41 from the outer ring member 42 through the balls 43. Then, based on this transmitted rotation torque, the inner ring member 41 and the first shaft portion 2 (the first connecting base portion 21) integrally rotate.

The second shaft portion 3 has a second connecting base portion 31 exposed from the second end portion 12 of the tube 1 and connected to the second joint portion 5, and a second inserting portion 32 extending in the axial direction from a front end portion of the second connecting base portion 31 and inserted into the inner peripheral portion 121 of the second end portion 12 of the tube 1. The second connecting base portion 31 and the second inserting portion 32 are formed integrally with each other with a metal material.

The second connecting base portion 31 has a second base portion 33, a second insertion-side connecting portion 34 formed into a step shape whose diameter is widened from a front end portion of the second base portion 33 and connecting to the second inserting portion 32, and a second joint-side connecting portion 35 formed into a step shape whose diameter is widened from a rear end portion of the second base portion 33 and connecting to the second joint portion 5. Here, the second connecting base portion 31 and the second joint portion 5 form a second body portion of the present invention.

The second inserting portion 32 is inserted into the inner peripheral portion 121 of the second end portion 12 of the tube 1 through a predetermined engagement means (serrations in the present embodiment), and is fixed to the tube 1 so as to be able to rotate integrally with the tube 1. More specifically, a second serration part 36 that can be serration-connected to the tube 1 is formed throughout an almost entire area in the axial direction on an outer peripheral side of the second inserting portion 32.

Here, in the present embodiment, an axial direction length of the second serration part 36 is set to be substantially the same as an axial direction length of the first serration part 26. In other words, a second biting length L2 set by the axial direction length of the second serration part 36 is set to be substantially the same as the first biting length L1 set by the axial direction length of the first serration part 26.

The second serration part 36 is formed so that grooves 361 recessed inward in the radial direction are formed so as to extend in a direction parallel to the rotation axis Z, and an outside diameter D2 of each tooth tip 362 is set to be slightly larger than the inside diameter R1 of the tube 1. That is, the second inserting portion 32 is press-fitted into an inside of the second end portion 12 of the tube 1, and each tooth tip 362 bites into an inner peripheral surface of the tube 1, then the second serration part 36 makes the second inserting portion 32 engage with the tube 1 so as to be able to integrally rotate with the tube 1. With this, the second inserting portion 32 is supported in a fixed state at the inner peripheral portion 121 of the second end portion 12 of the tube 1 through the second serration part 36.

Here, in the present embodiment, the outside diameter D2 of the tooth tip 362 of the second serration part 36 is set to be substantially the same as the outside diameter D1 of the tooth tip 262 of the first serration part 26. In other words, a second biting amount X2 of the second serration part 36 is set to be substantially the same as the first biting amount X1 of the first serration part 26.

Here, a second collision load F2, which releases the fixed state between the second inserting portion 32 and the tube 1 and causes the second inserting portion 32 to start moving from the second end portion 12 toward the first end portion 11 at the inner peripheral portion of the tube 1, is set between the second serration part 36 and the tube 1. In the same manner as the first collision load F1, the second collision load F2 can be set based on an arbitrary engaging element such as the biting length L2 of the second serration part 36 engaging with (biting into) the inner peripheral portion 121 of the second end portion 12 of the tube 1 and the biting amount X2.

In the present embodiment, the second biting length L2 and the second biting amount X2 of the second serration part 36 are set to be the same as the first biting length L1 and the first biting amount X1 of the first serration part 26 respectively. Therefore, the second collision load F2 is set to be substantially the same as the first collision load F1.

The second joint portion 5 is formed by a so-called rubber coupling. The second joint portion 5 is provided at an opposite side to the tube 1 in the axial direction with respect to the second shaft portion 3. The second joint portion 5 is substantially annular in shape, and has three first bolt penetration holes 51 arranged at regular intervals in a circumferential direction of the second joint portion 5 and serving for connection to the second joint-side connecting portion 35 of the second shaft portion 3, and three second bolt penetration holes 52 arranged at regular intervals in the circumferential direction of the second joint portion 5 between the first bolt penetration holes 51 and serving for connection to the second power transmission device P2.

That is, the second joint-side connecting portion 35 formed into a trifurcated shape and the second joint portion 5 are connected with first bolts 61 penetrating the respective first bolt penetration holes 51, and are fixed so as to be able to integrally rotate. On the other hand, the second power transmission device P2 formed into a trifurcated shape and the second joint portion 5 are connected with second bolts (not shown) penetrating the respective second bolt penetration holes 52, and are fixed so as to be able to integrally rotate.

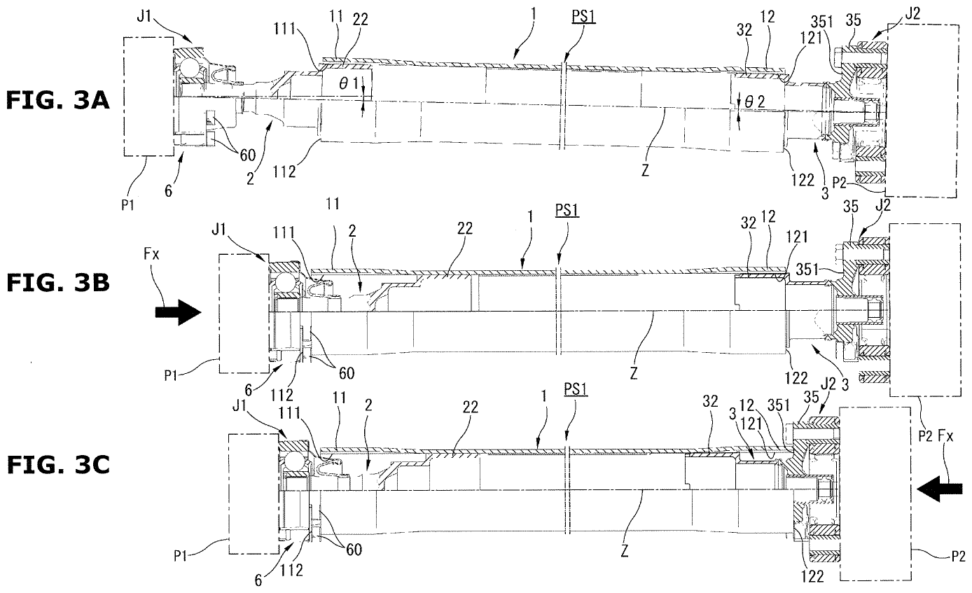

In the present embodiment, as described above, the second joint portion 5 is formed by the rubber coupling. Therefore, the second joint portion 5 is harder to bend than the first joint portion 4 formed by the constant-velocity joint. That is, regarding the second joint portion 5, a second bending load B2 that is a load required when the second joint portion 5 bends with respect to the rotation axis Z is greater than a first bending load B1 that is a load required when the first joint portion 4 bends with respect to the rotation axis Z. In other words, the propeller shaft PS1 is configured so that the first joint portion 4 bends at a relatively large first bending angle θ1 with respect to the rotation axis Z, and the second joint portion 5 bends at a relatively small second bending angle θ2 with respect to the rotation axis Z (see FIGS. 3A, 4A and 5A).

Further, the second joint portion 5 is formed so that an outside diameter D4 of the second joint portion 5 is set to be larger than an outside diameter D2 of the second inserting portion 32. More specifically, the second joint portion 5 is formed so that when the second shaft portion 3 penetrates into the inside of the tube 1 upon collision of the vehicle at the rear side, an inner end surface 351 of the second joint-side connecting portion 35 can come into contact with an end surface (a second end surface 122), located at the second end portion 12 side, of the tube 1. Here, in the present embodiment, the second collapse length S2 by which the second shaft portion 3 penetrates into the inner peripheral portion 121 of the second end portion 12 of the tube 1 upon occurrence of an after-described collapse is set by a distance between the second end surface 122 of the tube 1 and the inner end surface 351 of the second joint-side connecting portion 35.

### Collapse Structure of Propeller Shaft

A collapse structure of the propeller shaft PS1 according to the present invention will be described below with reference to FIGS. 3A to 5B. In the following description, “collapse” means that the fixed state of the first inserting portion 22 and the second inserting portion 32 to the tube 1 is released (destroyed) by an input of an axial direction load Fx into the propeller shaft PS1, and the first shaft portion 2 (the first connecting base portion 21) and the second shaft portion 3 (the second connecting base portion 31) penetrate into the inside of the tube 1.

By the collapse having occurred at the first end portion 11 side or the second end portion 12 side of the tube 1, the axial direction load Fx is buffered, and collision energy of the vehicle is absorbed. In other words, by the first connecting base portion 21 or the second connecting base portion 31 each penetrating into the inside of the tube 1 properly, the axial direction load Fx is buffered properly, then problem such as bending of the propeller shaft PS1 to a vehicle body side can be suppressed.

FIGS. 3A to 3C are longitudinal cross sections of the power transmission shaft shown in FIG. 2, showing conditions of the power transmission shaft to which a collision load is input from a vehicle front side. FIG. 3A shows a condition of the power transmission shaft in which the collapse has not occurred. FIG. 3B shows a condition of the power transmission shaft in which the collapse has occurred at the first end portion 11 side of a tube. FIG. 3C shows a condition of the power transmission shaft in which the collapse has occurred at the second end portion 12 side of the tube.

As illustrated in FIGS. 3A to 3C, when the vehicle collides from the vehicle front and the axial direction load Fx in a compression direction which is greater than the first collision load F1 acts on the propeller shaft PS1 from a front end side of the propeller shaft PS1, the axial direction load Fx is transmitted from the first power transmission device P1 to the first shaft portion 2 through the first joint portion 4. Then, first, the collapse occurs at the first end portion 11 side of the tube 1 from a normal condition shown in FIG. 3A.

More specifically, as illustrated in FIG. 3B, between the first shaft portion 2 to which the axial direction load Fx that is greater than the first collision load F1 is input and the tube 1, the fixed state between the first end portion 11 of the tube 1 and the first inserting portion 22 is released (destroyed), and the first connecting base portion 21 penetrates into the inner peripheral portion 111 of the first end portion 11 of the tube 1. More specifically, at the inner peripheral portion 111 of the first end portion 11 of the tube 1, the first inserting portion 22 moves from the first end portion 11 toward the second end portion 12 until the head portion(s) 60 of the bolt(s) 6 of the first joint portion 4 comes into contact with the first end surface 112 of the tube 1.

Subsequently, the axial direction load Fx is transmitted from the first shaft portion 2 to the second shaft portion 3 through the tube 1, and by reaction to the second shaft portion 3 that is located (sandwiched) between the second power transmission device P2 and the tube 1, the axial direction load Fx acts on the second shaft portion 3 from the second power transmission device P2. Then, with a delay after the collapse at the first end portion 11 side, the collapse occurs at the second end portion 12 side of the tube 1.

That is, as illustrated in FIG. 3C, between the second shaft portion 3 having received an input of the axial direction load Fx that is greater than the second collision load F2 and the tube 1, the fixed state between the second end portion 12 of the tube 1 and the second inserting portion 32 is released (destroyed), and the second connecting base portion 31 penetrates into the inside of the second end portion 12 of the tube 1. More specifically, at the second end portion 12 of the tube 1, the second inserting portion 32 moves from the second end portion 12 toward the first end portion 11 until the inner end surface 351 of the second joint-side connecting portion 35 comes into contact with the second end surface 122 of the tube 1.

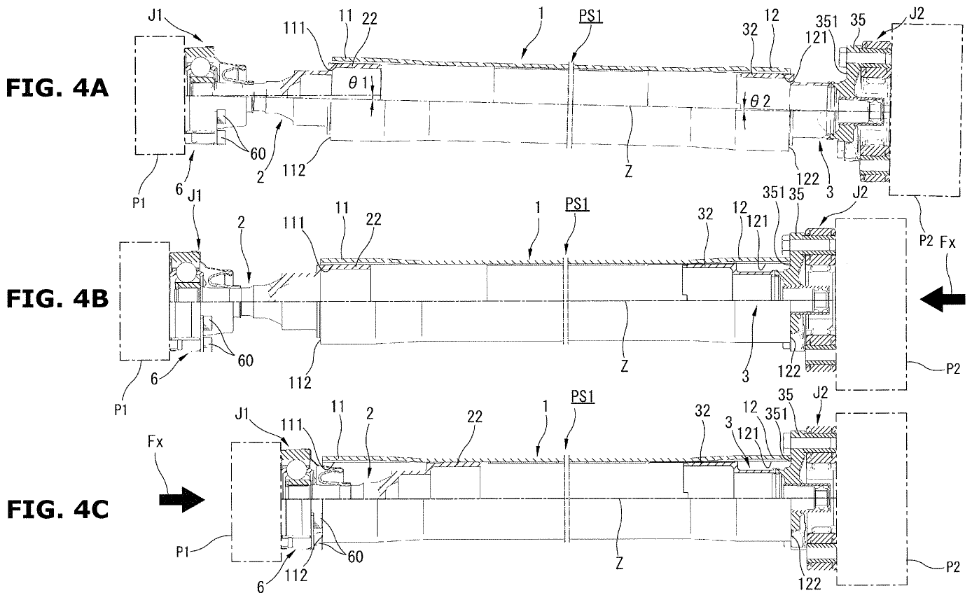

FIGS. 4A to 4C are longitudinal cross sections of the power transmission shaft shown in FIG. 2, showing conditions of the power transmission shaft to which the collision load is input from a vehicle rear side. FIG. 4A shows a condition of the power transmission shaft in which the collapse has not occurred. FIG. 4B shows a condition of the power transmission shaft in which the collapse has occurred at the second end portion 12 side of the tube. FIG. 4C shows a condition of the power transmission shaft in which the collapse has occurred at the first end portion 11 side of the tube.

As illustrated in FIGS. 4A to 4C, when the vehicle collides from the vehicle rear and the axial direction load Fx in a compression direction which is greater than the second collision load F2 acts on the propeller shaft PS1 from a rear end side of the propeller shaft PS1, the axial direction load Fx is transmitted from the second power transmission device P2 to the second shaft portion 3 through the second joint portion 5. Then, first, the collapse occurs at the second end portion 12 side of the tube 1 from a normal condition shown in FIG. 4A.

More specifically, as illustrated in FIG. 4B, between the second shaft portion 3 to which the axial direction load Fx that is greater than the second collision load F2 is input and the tube 1, the fixed state between the second end portion 12 of the tube 1 and the second inserting portion 32 is released (destroyed), and the second connecting base portion 31 penetrates into the inner peripheral portion 121 of the second end portion 12 of the tube 1. More specifically, at the inner peripheral portion 121 of the second end portion 12 of the tube 1, the second inserting portion 32 moves from the second end portion 12 toward the first end portion 11 until the inner end surface 351 of the second joint-side connecting portion 35 comes into contact with the second end surface 122 of the tube 1.

Subsequently, the axial direction load Fx is transmitted from the second shaft portion 3 to the first shaft portion 2 through the tube 1, and by reaction to the first shaft portion 2 that is located (sandwiched) between the first power transmission device P1 and the tube 1, the axial direction load Fx acts on first shaft portion 2 from the first power transmission device P1. Then, with a delay after the collapse at the second end portion 12 side, the collapse occurs at the first end portion 11 side of the tube 1.

That is, as illustrated in FIG. 4C, between the first shaft portion 2 having received an input of the axial direction load Fx that is greater than the first collision load F1 and the tube 1, the fixed state between the first end portion 11 of the tube 1 and the first inserting portion 22 is released (destroyed), and the first connecting base portion 21 penetrates into the inside of the first end portion 11 of the tube 1. More specifically, at the inner peripheral portion 111 of the first end portion 11 of the tube 1, the first inserting portion 22 moves from the first end portion 11 toward the second end portion 12 until the head portion(s) 60 of the bolt(s) 6 of the first joint portion 4 comes into contact with the first end surface 112 of the tube 1.

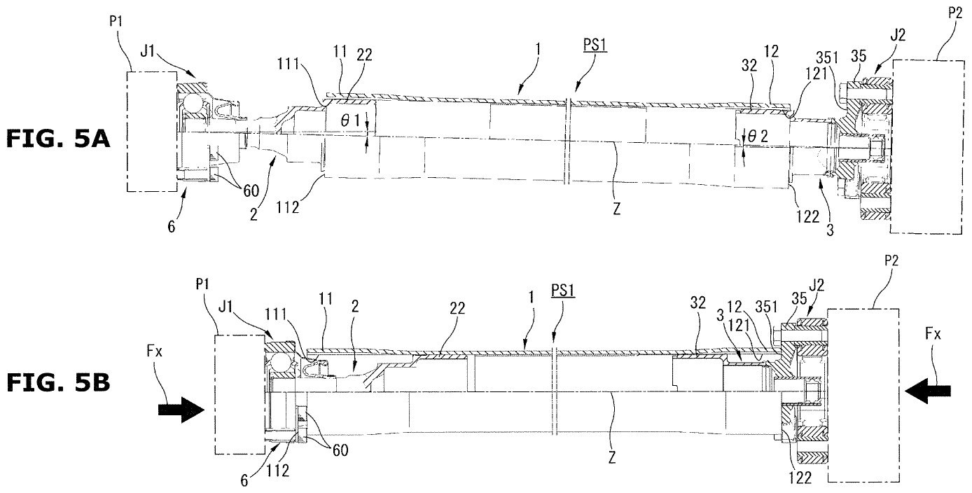

FIGS. 5A and 5B are longitudinal cross sections of the power transmission shaft shown in FIG. 2, showing conditions of the power transmission shaft to which the collision load is input from the vehicle front and rear sides. FIG. 5A shows a condition of the power transmission shaft in which the collapse has not occurred. FIG. 5B shows a condition of the power transmission shaft in which the collapse has occurred at the first end portion 11 side and the second end portion 12 side of the tube.

As illustrated in FIGS. 5A and 5B, when the vehicle collides in the vehicle front and rear directions and the axial direction loads Fx in compression directions which are greater than the first collision load F1 and the second collision load F2 act on the propeller shaft PS1 from front and rear end sides of the propeller shaft PS1, the axial direction loads Fx are transmitted from the first power transmission device P1 and the second power transmission device P2 to the first shaft portion 2 and the second shaft portion 3 through the first joint portion 4 and the second joint portion 5 respectively. Then, the collapse occurs at the first end portion 11 side and the second end portion 12 side of the tube 1 at the same time from a normal condition shown in FIG. 5A.

More specifically, as illustrated in FIG. 5B, between the first shaft portion 2 having received an input of the axial direction load Fx that is greater than the first collision load F1 and the tube 1, the fixed state between the first end portion 11 of the tube 1 and the first inserting portion 22 is released (destroyed), and the first connecting base portion 21 penetrates into the inner peripheral portion 111 of the first end portion 11 of the tube 1. Also, at the same time, between the second shaft portion 3 having received an input of the axial direction load Fx that is greater than the second collision load F2 and the tube 1, the fixed state between the second end portion 12 of the tube 1 and the second inserting portion 32 is released (destroyed), and the second connecting base portion 31 penetrates into the inner peripheral portion 121 of the second end portion 12 of the tube 1.

More specifically, at the inner peripheral portion 111 of the first end portion 11 of the tube 1, the first inserting portion 22 moves from the first end portion 11 toward the second end portion 12 until the head portion(s) 60 of the bolt(s) 6 of the first joint portion 4 comes into contact with the first end surface 112 of the tube 1. Also, at the same time, at the inner peripheral portion 121 of the second end portion 12 of the tube 1, the second inserting portion 32 moves from the second end portion 12 toward the first end portion 11 until the inner end surface 351 of the second joint-side connecting portion 35 comes into contact with the second end surface 122 of the tube 1.

### Working and Effect of the Present Embodiment

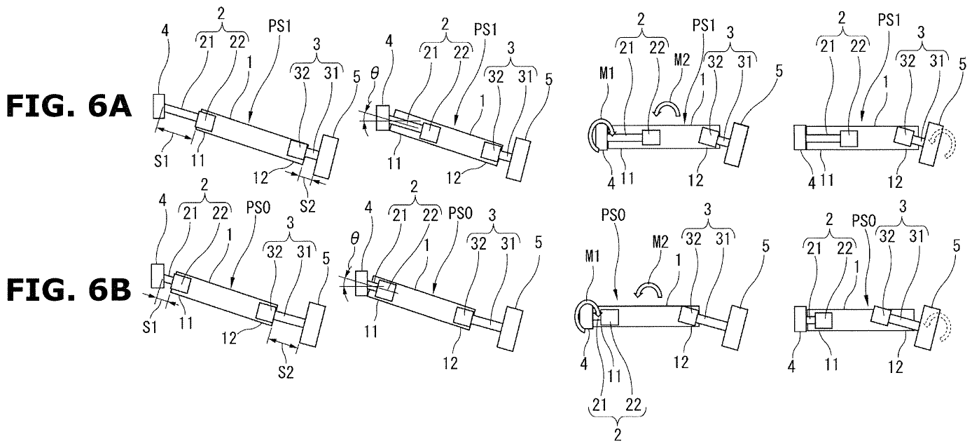

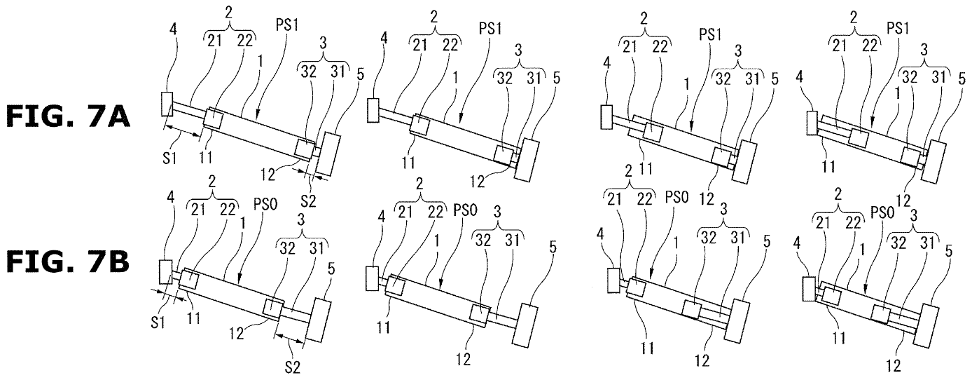

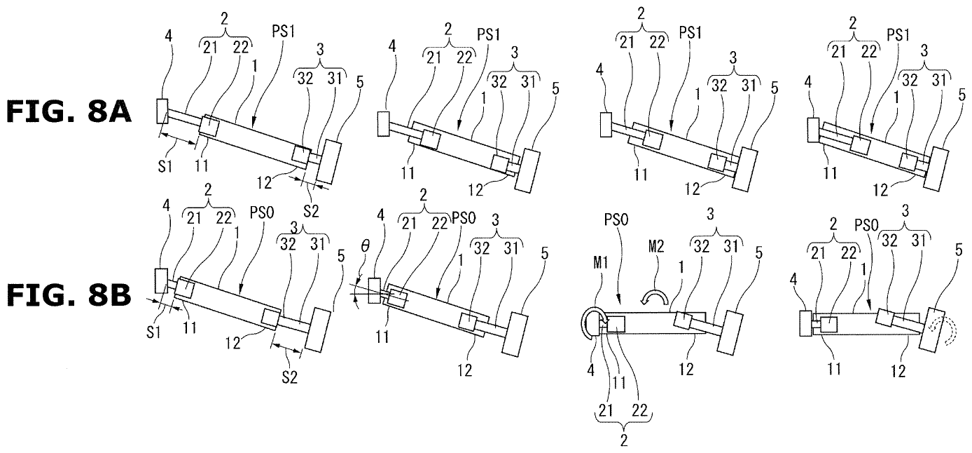

FIGS. 6A and 6B are schematic diagrams for explaining working and effect of the present invention when the collapse has occurred from the first end portion side. FIG. 6A shows a state of the collapse of the power transmission shaft according to the present invention. FIG. 6B shows a state of the collapse of a conventional power transmission shaft. FIGS. 7A and 7B are schematic diagrams for explaining working and effect of the present invention when the collapse has occurred from the second end portion side. FIG. 7A shows a state of the collapse of the power transmission shaft according to the present invention. FIG. 7B shows a state of the collapse of the conventional power transmission shaft. FIGS. 8A and 8B are schematic diagrams for explaining working and effect of the present invention when the collapse has occurred from both of the first end portion side and the second end portion side. FIG. 8A shows a state of the collapse of the power transmission shaft according to the present invention. FIG. 8B shows a state of the collapse of the conventional power transmission shaft.

In a case of the conventional propeller shaft PS0, a relationship of length between a first collapse length S1 by which the first shaft portion 2 connected to the first joint portion 4 formed by the constant-velocity joint that is relatively easy to bend penetrates into the inside of the tube 1 and a second collapse length S2 by which the second shaft portion 3 connected to the second joint portion 5 formed by the rubber coupling that is relatively hard to bend penetrates into the inside of the tube 1 is not taken into consideration at all. Therefore, in the case of the conventional propeller shaft PS0 in which the second collapse length S2 is longer than the first collapse length S1, there is room for improvement in that collision performance of the propeller shaft PS0 becomes unstable.

More specifically, as illustrated in FIG. 6B, when the axial direction load Fx is input from the vehicle front (the first end portion 11 side), first, the collapse occurs at the first end portion 11 side. By this collapse, the first inserting portion 22 of the first joint member J1 having the relatively small first bending load B1 and being relatively easy to bend moves from the first end portion 11 side toward the second end portion 12, and the first connecting base portion 21 is inserted (penetrates) into the inside of the tube 1, then the first joint portion 4 comes into contact with the first end surface 112 of the tube 1. Here, when the first joint portion 4 comes into contact with the tube 1 at an angle θ, a first moment M1 is generated at the first joint portion 4 so that the first joint portion 4 and the first end surface 112 of the tube 1 coincide with each other, and a second moment M2 is generated at the tube 1 and acts on the tube 1 so as to lift the second end portion 12 side of the tube 1. Then, in the case of the conventional propeller shaft PS0 in which the second collapse length S2 is longer than the first collapse length S1, the angle θ is formed between the second shaft portion 3 and the tube 1. Because of this, the second shaft portion 3 gets caught on (or strikes against) the inner peripheral portion 121 of the second end portion 12 of the tube 1, and this makes the second shaft portion 3 harder to insert (penetrate) into the inside of the tube 1. As a consequence, there is a risk that the collision performance of the propeller shaft PS0 will become worse.

On the other hand, as illustrated in FIG. 7B, when the axial direction load Fx is input from the vehicle rear (the second end portion 12 side), first, the collapse occurs at the second end portion 12 side. In this case, in the case of the conventional propeller shaft PS0 in which the second collapse length S2 is longer than the first collapse length S1, first, the relatively long second shaft portion 3 is inserted (penetrates) into the inside of the tube 1. This allows the first shaft portion 2 to be inserted relatively smoothly into the inside of the tube 1, and the collision performance of the propeller shaft PS0 will not become worse.

Further, as illustrated in FIG. 8B, when the axial direction loads Fx are input from the front and rear directions (from the first end portion 11 side and the second end portion 12 side), the collapse occurs at the first end portion 11 side and the second end portion 12 side at the same time. By these collapses, the first inserting portion 22 moves from the first end portion 11 side toward the second end portion 12, and the first connecting base portion 21 is inserted (penetrates) into the inside of the tube 1, and at the same time, the second inserting portion 32 moves from the second end portion 12 side toward the first end portion 11, and the second connecting base portion 31 is inserted (penetrates) into the inside of the tube 1. Here, in the case of the conventional propeller shaft PS0 in which the second collapse length S2 is longer than the first collapse length S1, before the second joint portion 5 comes into contact with the second end surface 122, the first joint portion 4 comes into contact with the first end surface 112. Since the first joint portion 4 having the relatively small first bending load B1 and the tube 1 come into contact with each other at the relatively large angle θ, the first moment M1 is generated at the first joint portion 4 so that the first joint portion 4 and the first end surface 112 of the tube 1 coincide with each other, and the second moment M2 is generated at the tube 1 and acts on the tube 1 so as to lift the second end portion 12 side of the tube 1. Due to this action, the angle θ is formed between the second shaft portion 3 and the tube 1, and the second shaft portion 3 gets caught on (or strikes against) the inner peripheral portion 121 of the second end portion 12 of the tube 1, and this makes the second shaft portion 3 harder to insert (penetrate) into the inside of the tube 1. As a consequence, there is a risk that the collision performance of the propeller shaft PS0 will become worse.

In contrast to this, in the case of the propeller shaft PS1 according to the present embodiment, the following working and effects can be brought about, then the above technical problem of the conventional propeller shaft can be solved.

The propeller shaft PS1 is a power transmission shaft (a propeller shaft) transmitting power between a first power transmission device P1 and a second power transmission device P2 of a vehicle, comprising: a tube 1 formed into a tubular shape; a first joint member J1 having a first body portion (a first connecting base portion 21, a first joint portion 4) and a first inserting portion 22, wherein the first inserting portion 22 is provided so that an outer peripheral portion of the first inserting portion 22 is supported in a fixed state at an inner peripheral portion 111 of a first end portion 11 of the tube 1, which is one of a pair of end portions of the first end portion 11 and a second end portion 12 in a direction of a rotation axis Z of the tube 1, and so that when an input load of a first collision load F1 or more acts on the first joint member J1, the fixed state between the first inserting portion 22 and the tube 1 is released and the first inserting portion 22 can move from the first end portion 11 toward the second end portion 12 of the tube 1, and wherein the first body portion (the first connecting base portion 21, the first joint portion 4) is provided at an opposite side to the first inserting portion 22 in the direction of the rotation axis Z with respect to the first end portion 11, and is connected to the first power transmission device P1 through the first joint portion 4 that can bend with respect to the direction of the rotation axis Z by a fact that a first bending load B1 acts on the first joint portion 4; and a second joint member J2 having a second body portion (a second connecting base portion 31, a second joint portion 5) and a second inserting portion 32, wherein the second inserting portion 32 is provided so that an outer peripheral portion of the second inserting portion 32 is supported in a fixed state at an inner peripheral portion 121 of the second end portion 12 of the tube 1, and so that when an input load of a second collision load F2 or more acts on the second joint member J2, the fixed state between the second inserting portion 32 and the tube 1 is released and the second inserting portion 32 can move from the second end portion 12 toward the first end portion 11 of the tube 1, and wherein the second body portion (the second connecting base portion 31, the second joint portion 5) is provided at an opposite side to the second inserting portion 32 in the direction of the rotation axis Z with respect to the second end portion 12, and is connected to the second power transmission device P2 through the second joint portion 5 for which a second bending load B2 required when the second joint portion 5 bends with respect to the direction of the rotation axis Z is set to be greater than the first bending load B1, and wherein the first joint member J1 and the second joint member J2 are formed so that when the input load acts on the first joint member J1 and the second joint member J2, a first collapse length S1 by which the first joint member J1 is inserted into the inner peripheral portion 111 of the tube 1 is longer than a second collapse length S2 by which the second joint member J2 is inserted into the inner peripheral portion 121 of the tube 1.

As described above, the propeller shaft PS1 according to the present embodiment is configured so that the first collapse length S1 of the first joint member J1 bends based on the first bending load B1 is set to be longer than the second collapse length S2 of the second joint member J2 bends based on the second bending load B2 that is greater than the first bending load B1.

Therefore, in the case where the front side (the first end portion 11 side) collapses first, as illustrated in FIG. 6A, when the first shaft portion 2 of the first joint member J1 having the relatively small first bending load B1 and being relatively easy to bend is inserted (penetrates) into the inside of the tube 1, the first moment M1 is generated at the first joint portion 4 so that the first joint portion 4 and the first end surface 112 of the tube 1 coincide with each other when the first joint portion 4 and the first end portion 11 of the tube 1 come into contact with each other at an angle θ, and also the second moment M2 is generated at the tube 1 and acts on the tube 1 so as to lift the second end portion 12 side of the tube 1. Although this makes the second shaft portion 3 have the angle θ with respect to the tube 1, since the second collapse length S2 is relatively shorter than the first collapse length S1, the second shaft portion 3 becomes easy to insert (penetrate) into the inside of the tube 1. It is therefore possible to improve stability of the collision performance of the propeller shaft PS1.

On the other hand, in the case where the rear side (the second end portion 12 side) collapses first, as illustrated in FIG. 7A, since the second bending load B2 is greater than the first bending load B1 and the second joint portion 5 is relatively hard to bend, an angle is not easily formed between the second shaft portion 3 and the tube 1 when the second shaft portion 3 is inserted (penetrates) into the inside of the tube 1. Therefore, even when the second joint portion 5 and the second end surface 122 of the tube 1 come into contact with each other so as to coincide with each other, a large moment (the first and second moments M1 and M2) does not act on the tube 1. Therefore, an angle is not easily formed between the first shaft portion 2 of the first joint member J1 and the tube 1, and the first shaft portion 2 becomes easy to insert (penetrate) into the inside of the tube 1. It is therefore possible to improve stability of the collision performance of the propeller shaft PS1.

Further, in the case where the first end portion 11 side and the second end portion 12 side collapse almost at the same time, as illustrated in FIG. 8A, since the second collapse length S2 is set to be relatively shorter than the first collapse length S1, before the first joint portion 4 comes into contact with the first end surface 112 of tube 1, the second joint portion 5 comes into contact with the second end surface 122 of tube 1. Further, at this time, since the second bending load B2 is greater than the first bending load B1 and the second joint portion 5 is relatively hard to bend, even when the second joint portion 5 and the second end surface 122 of the tube 1 come into contact with each other so as to coincide with each other, a large moment (the first and second moments M1 and M2) does not act on the tube 1. As a result, an angle is not easily formed between the first shaft portion 2 of the first joint member J1 and the tube 1, and the first shaft portion 2 becomes easy to insert (penetrate) into the inside of the tube 1. It is therefore possible to improve stability of the collision performance of the propeller shaft PS1.

Further, in the present embodiment, when the input load acts on the first joint member J1 and the second joint member J2, a first time required for the first joint portion 4 to come into contact with the first end portion 11 of the tube 1 is longer than a second time required for the second joint portion 5 to come into contact with the second end portion 12 of the tube 1.

As described above, in the present embodiment, the first time required for the first joint portion 4 to come into contact with the first end portion 11 of the tube 1 is longer than the second time required for the second joint portion 5 to come into contact with the second end portion 12 of the tube 1. Therefore, in the case where the second end portion 12 side collapses first, or in the case where the first end portion 11 side and the second end portion 12 side collapse at the same time, before the first joint portion 4 comes into contact with the first end portion 11 of the tube 1, the second joint portion 5 comes into contact with the second end portion 12 of the tube 1. In this case, even when the second joint portion 5 and the second end surface 122 of the tube 1 come into contact with each other so as to coincide with each other, a large moment (the first and second moments M1 and M2) does not act on the tube 1. As a result, an angle is not easily formed between the first shaft portion 2 of the first joint member J1 and the tube 1, and the first shaft portion 2 becomes easy to insert (penetrate) into the inside of the tube 1. It is therefore possible to improve stability of the collision performance of the propeller shaft PS1.

Further, in the present embodiment, the first joint member J1 is connected to the first power transmission device P1 through a constant-velocity joint.

As described above, in the present embodiment, the first joint member J1 is connected to the first power transmission device P1 through the first joint portion 4 formed by the constant-velocity joint. With this, as compared with a case where the first joint portion 4 is formed by a cardan joint, variations in bending load are small. Thus, as a merit, it is possible to easily stabilize the collision performance of the propeller shaft PS1.

Further, in the present embodiment, the constant-velocity joint (the first joint portion 4) is fastened to the first power transmission device P1 with bolts 6 screwed from the tube 1 side toward the first power transmission device P1 side, and the first collapse length S1 is a distance from the first end portion 11 of the tube 1 to a head portion 60 of the bolt 6.

As described above, in the present embodiment, the first joint portion 4 formed by the constant-velocity joint is fastened to the first power transmission device P1 with the bolts 6. This bolt fastening is a general-purpose connecting means, thereby lowering a manufacturing cost of the propeller shaft PS1 and improving mounting-workability of the propeller shaft PS1 onto a vehicle V.

Further, the first collapse length S1 is set by the distance from the first end portion 11 of the tube 1 to the head portion 60 of the bolt 6. Therefore, as a merit, it is possible to readily adjust the first collapse length S1 by adjusting a height of the head portion 60 of the bolt 6.

Further, in the present embodiment, the second joint member J2 is connected to the second power transmission device P2 through a rubber coupling, and the second collapse length S2 is a distance from the second end portion 12 of the tube 1 to a yoke (the second joint-side connecting portion 35) connected to the rubber coupling.

As described above, in the present embodiment, the second joint member J2 is connected to the second power transmission device P2 through the second joint portion 5 formed by the rubber coupling. Therefore, vibration of the vehicle V can be absorbed by the rubber coupling, thereby improving noise-vibration performance of the vehicle V.

Further, the second collapse length S2 is set by the distance from the second end portion 12 of the tube 1 to the second joint-side connecting portion 35 that is the yoke connected to the rubber coupling. Since the rubber coupling (the second joint portion 5) forms a flat surface extending in a direction orthogonal to the direction of the rotation axis Z, by making the flat surface of the rubber coupling (the second joint portion 5) come into contact with the second end surface 122 of the tube 1, the stability of the collision performance of the propeller shaft PS1 can be improved.

Further, in the present embodiment, a rotation axis of the first body portion (the first connecting base portion 21, the first joint portion 4) is connected to the first power transmission device P1 at a first bending angle θ1 with respect to the rotation axis Z of the tube 1, a rotation axis of the second body portion (the second connecting base portion 31, the second joint portion 5) is connected to the second power transmission device P2 at a second bending angle θ2 with respect to the rotation axis Z of the tube 1, and the first bending angle θ1 is smaller than the second bending angle θ2.

As described above, in the present embodiment, the first bending angle θ1 of the first joint member J1 is set to be smaller than the second bending angle θ2 of the second joint member J2. Normally, if a large bending angle is formed at something having a large bending load, there is a risk that noise and vibration will occur. Therefore, by setting the first bending angle θ1 of the first joint member J1 having a relatively large bending load to be large and the second bending angle θ2 of the second joint member J2 having a relatively small bending load to be small, occurrence of the noise and vibration is suppressed, and noise-vibration performance of the propeller shaft PS1 can be improved.

Further, if a large bending angle is formed at something having a relatively large bending load, due to this large bending, great heat is generated. Then, due to this heat generation, a part of motive energy (power energy) is lost, and power transmission efficiency may be decreased. Therefore, by setting the first bending angle θ1 of the first joint member J1 having a relatively large bending load to be large and the second bending angle θ2 of the second joint member J2 having a relatively small bending load to be small, the loss of the motive energy (power energy) due to the bending of the second joint member J2 can be reduced, thereby improving the power transmission efficiency of the propeller shaft PS1.

Further, in the present embodiment, at least either one of the first inserting portion 22 and the second inserting portion 32 is connected to the inner peripheral portion of the tube 1 through a serration.

As described above, in the present embodiment, the first inserting portion 22 is connected to the inner peripheral portion 111 of the first end portion 11 of the tube 1 through the first serration part 26, and the second inserting portion 32 is connected to the inner peripheral portion 121 of the second end portion 12 of the tube 1 through the second serration part 36. Therefore, for instance, as compared with a case where the first inserting portion 22 and the second inserting portion 32 whose outer peripheral surfaces are formed into a substantially flat shape are connected to the inner peripheral surface of the tube 1 by a mere press-fitting or with a mere adhesive, the first inserting portion 22 and the second inserting portion 32 can be fixed to the tube 1 more firmly. With this, large torque resistance performance in the rotation direction of the propeller shaft PS1 can be ensured, and a large holding load in the axial direction of the propeller shaft PS1 can be obtained.

Further, in the present embodiment, the first power transmission device P1 is a transmission TM of the vehicle V, the second power transmission device P2 is a differential gear DF of the vehicle V, and the second joint member J2 is formed by a rubber coupling.

As described above, in the present embodiment, the second joint member J2 connecting the propeller shaft PS1 and the differential gear DF of the vehicle V is formed by the rubber coupling. Therefore, vibration of the differential gear DF can be absorbed and blocked by the rubber coupling, thereby improving noise-vibration performance of the propeller shaft PS1.

Further, in the present embodiment, the tube 1 is made of a material formed by solidifying fiber with resin.

As described above, in the present embodiment, the tube 1 is made of the fiber reinforced resin material formed by solidifying the fiber with the resin. Therefore, as compared with a case where the tube 1 is made of a metal material, the tube 1 can be lightened, thereby improving fuel efficiency.

Further, since the tube 1 is made of the fiber reinforced resin material, as compared with the case where the tube 1 is made of the metal material, sound reverberation in the tube 1 can be reduced, and this also contributes to improving the noise-vibration performance of the propeller shaft PS1.

In particular, in the present embodiment, the tube 1 is made of the carbon fiber reinforced resin material (the carbon fiber reinforced plastic) (CFRP).

As described above, in the present embodiment, since the tube 1 is made of the carbon fiber reinforced resin material (CFRP), as compared with a case where the tube 1 is made of other fiber reinforced resins, e.g. a glass fiber reinforced resin (glass fiber reinforced plastic) (FRP), strength of the tube 1 becomes high, and also the tube 1 can be further lightened.

Further, as another example of the present embodiment, as mentioned in the above description, the tube 1 could be made of the glass fiber reinforced resin (FRP). In this case, as compared with a case where the tube 1 is made of other fiber reinforced resins, e.g. the carbon fiber reinforced resin material (CFRP), the tube 1 can be formed at lower cost.

### Second Embodiment

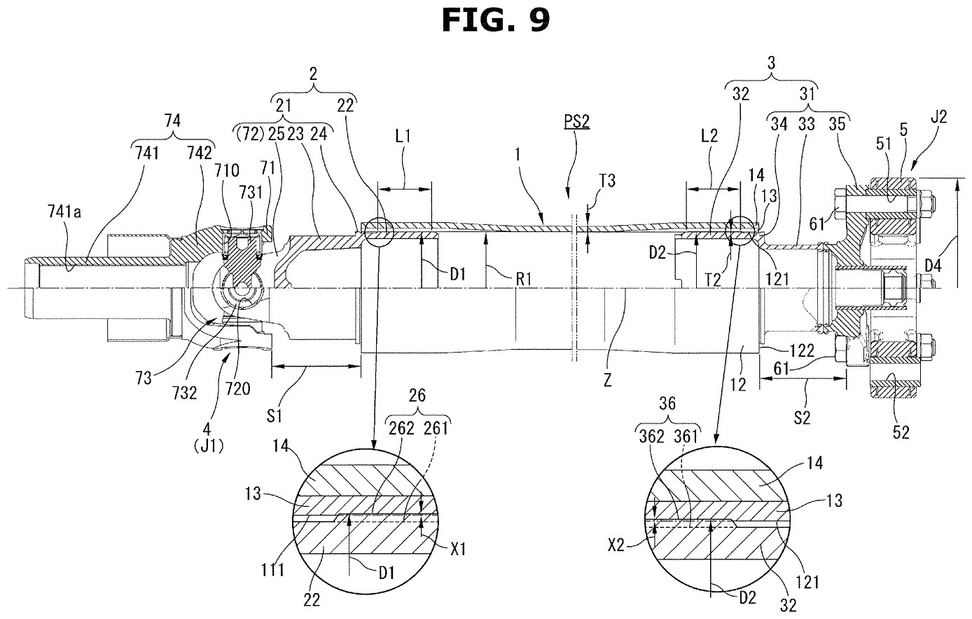

FIG. 9 shows a second embodiment of the power transmission shaft (the propeller shaft) according to the present invention, in which a configuration of the first joint member J1 of the propeller shaft PS1 according to the first embodiment is changed. Since a basic structure or configuration of the second embodiment except the changes is the same as that of the first embodiment, the same structure or configuration as that of the first embodiment is denoted by the same reference sign, and its detailed description is omitted here. In the following description of the present embodiment, for the sake of convenience, a left side in FIG. 9 is referred to as a “front”, and a right side is referred to as a “rear”. Further, a direction along a rotation axis Z in FIG. 9 is referred to as an “axial direction”, a direction orthogonal to the rotation axis Z is referred to as a “radial direction”, and a direction of rotation about the rotation axis Z is referred to as a “circumferential direction”.

### Configuration of Propeller Shaft

FIG. 9 shows an entire propeller shaft PS2 according to the second embodiment of the present invention. FIG. 9 is a longitudinal cross section of the propeller shaft PS2, cut along the direction of the rotation axis Z.

As illustrated in FIG. 9, the first joint portion 4 of the first joint member J1 of the propeller shaft PS2 according to the present embodiment is formed by a well-known cardan joint, instead of the constant-velocity joint of the first embodiment. That is, the first joint member J1 has a first yoke 71 connected to the transmission TM (see FIG. 1) corresponding to the first power transmission device P1, a second yoke 72 connected to the tube 1, and a cruciform shaft 73 disposed between the first yoke 71 and the second yoke 72.

The first yoke 71 has a bifurcated shape that faces each other in the radial direction, and first shaft insertion holes 710 into which a pair of first shaft portions 731 of the cruciform shaft 73 are inserted are formed so as to penetrate the first yoke 71 along the radial direction. The first yoke 71 is formed integrally with a connecting shaft portion 74 that extends toward the transmission TM (see FIG. 1) in the axial direction, and is connected to an output shaft (not shown) of the transmission TM through the connecting shaft portion 74.

The connecting shaft portion 74 has a vehicle-side connecting portion 741 connected to the output shaft (not shown) of the transmission TM through a spline, and a yoke-side connecting portion 742 formed into a step shape whose diameter is widened at a rear end side of the vehicle-side connecting portion 741 and connected to the first yoke 71. The vehicle-side connecting portion 741 and the yoke-side connecting portion 742 are formed integrally with each other. The vehicle-side connecting portion 741 is formed into a substantially cylindrical tubular shape, and is inserted into a transmission case (not shown) of the transmission TM. Further, a female spline portion 741a formed at an inner peripheral side of the vehicle-side connecting portion 741 is spline-connected to a male spline portion provided at an outer peripheral side of the output shaft (not shown) of the transmission TM, then the vehicle-side connecting portion 741 is connected to the transmission TM so as to be able to relatively move in the axial direction.

The second yoke 72 has a bifurcated shape that faces each other in the radial direction, and second shaft insertion holes 720 into which another pair of second shaft portions 732 of the cruciform shaft 73 are inserted are formed so as to penetrate the second yoke 72 along the radial direction. The bifurcated second yoke 72 and the bifurcated first yoke 71 are arranged in a staggered formation. Further, the second yoke 72 is formed integrally with the first connecting base portion 21 of the first shaft portion 2, and forms the first joint-side connecting portion 25. The second yoke 72 is connected to the tube 1 through the first inserting portion 22.

### Working and Effect of the Present Embodiment

As described above, in the propeller shaft PS2 according to the present embodiment, the first joint member J1 is connected to the first power transmission device P1 (see FIG. 1) through a cardan joint.

As described above, in the present embodiment, the first joint member J1 is connected to the first power transmission device P1 through the cardan joint. With this, as compared with the case where the first joint member J1 is formed by the constant-velocity joint, as a merit, it is possible to lower a manufacturing cost of the propeller shaft PS2.

### Third Embodiment

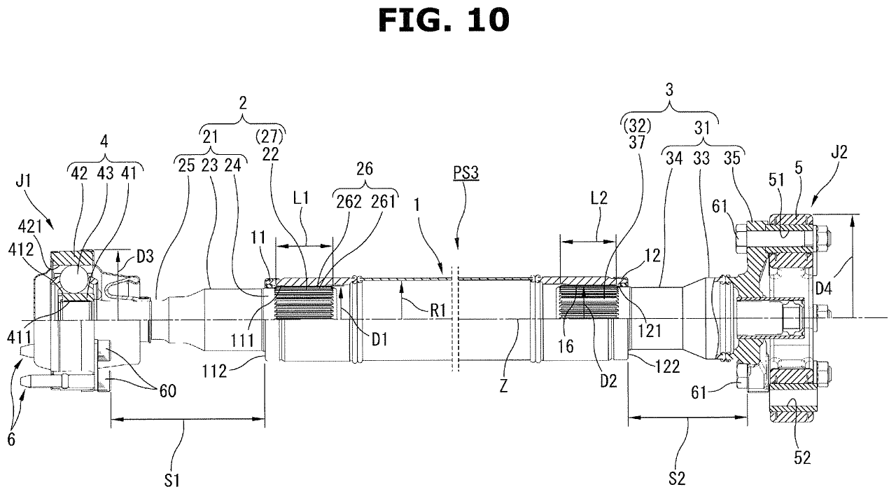

FIG. 10 shows a third embodiment of the power transmission shaft (the propeller shaft) according to the present invention, in which configurations of the first inserting portion 22 and the second inserting portion 32 of the propeller shaft PS1 according to the first embodiment are changed. Since a basic structure or configuration of the third embodiment except the changes is the same as that of the first embodiment, the same structure or configuration as that of the first embodiment is denoted by the same reference sign, and its detailed description is omitted here. In the following description of the present embodiment, for the sake of convenience, a left side in FIG. 10 is referred to as a “front”, and a right side is referred to as a “rear”. Further, a direction along a rotation axis Z in FIG. 10 is referred to as an “axial direction”, a direction orthogonal to the rotation axis Z is referred to as a “radial direction”, and a direction of rotation about the rotation axis Z is referred to as a “circumferential direction”.

### Configuration of Propeller Shaft

FIG. 10 shows an entire propeller shaft PS3 according to the third embodiment of the present invention. FIG. 10 is a longitudinal cross section of the propeller shaft PS3, cut along the direction of the rotation axis Z.

As illustrated in FIG. 10, the tube 1 of the propeller shaft PS3 according to the present embodiment is made of a metal material. Further, in the propeller shaft PS3, the first inserting portion 22 is spline-connected to the first end portion 11 of the tube 1, and the second inserting portion 32 is spline-connected to the second end portion 12 of the tube 1.

That is, a first female spline portion 15 having a well-known spline extending along the axial direction is formed at the inner peripheral portion 111 of the first end portion 11 of the tube 1. On the other hand, a first male spline portion 27 having a well-known spline engaging with the first female spline portion 15 and being movable in the axial direction along the first female spline portion 15 is formed at the outer peripheral portion of the first inserting portion 22 of the tube 1. Then, the first inserting portion 22 is press-fitted into the first female spline portion 15 of the tube 1 through the first male spline portion 27.

In the same manner as the first end portion 11, a second female spline portion 16 having a well-known spline extending along the axial direction is formed at the inner peripheral portion 121 of the second end portion 12 of the tube 1. On the other hand, a second male spline portion 37 having a well-known spline engaging with the second female spline portion 16 and being movable in the axial direction along the second female spline portion 16 is formed at the outer peripheral portion of the second inserting portion 32 of the tube 1. Then, the second inserting portion 32 is press-fitted into the second female spline portion 16 of the tube 1 through the second male spline portion 37.

### Working and Effect of the Present Embodiment

As described above, in the propeller shaft PS3 according to the present embodiment, at least either one of the first inserting portion 22 and the second inserting portion 32 is spline-connected to the inner peripheral portion of the tube 1.

As described above, in the present embodiment, the first inserting portion 22 and the second inserting portion 32 are each spline-connected to the inner peripheral portion of the tube 1. Therefore, as compared with the case where the first inserting portion 22 and the second inserting portion 32 are each serration-connected to the inner peripheral portion of the tube 1, the collapse can occur by a smaller collision load. This can contribute to stabilization of the collision performance of the propeller shaft PS3 by controlling the occurrence of the collapse.

Further, in the present embodiment, the tube 1 is made of a metal material.

As described above, in the present embodiment, the tube 1 is made of the metal material. Therefore, the tube 1 can be formed at a low cost, thereby contributing to lowering a manufacturing cost of the propeller shaft PS3.

Further, in the present embodiment, the first inserting portion 22 has a first male spline portion 27 engaging with a first female spline portion 15 formed at the inner peripheral portion of the tube (1).

As described above, in the present embodiment, the first inserting portion 22 is spline-connected to the tube 1 through the first male spline portion 27 engaging with the first female spline portion 15 of the tube 1. Therefore, as compared with the case where the tube 1 is made of the fiber reinforced resin, the propeller shaft PS3 can be manufactured at a relatively low cost. Also, backlash or play between the first inserting portion 22 and the tube 1 at the first end portion 11 can be reduced. Thus, as a merit, good torque transmission from the first inserting portion 22 to the tube 1 can be achieved.

Further, in the present embodiment, the second inserting portion 32 has a second male spline portion 37 engaging with a second female spline portion 16 formed at the inner peripheral portion of the tube 1.

As described above, in the present embodiment, the second inserting portion 32 is spline-connected to the tube 1 through the second male spline portion 37 engaging with the second female spline portion 16 of the tube 1. Therefore, as compared with the case where the tube 1 is made of the fiber reinforced resin, the propeller shaft PS3 can be manufactured at a relatively low cost. Also, backlash or play between the second inserting portion 32 and the tube 1 at the second end portion 12 can be reduced. Thus, as a merit, good torque transmission from the tube 1 to the second inserting portion 32 can be achieved.

The present invention is not limited to the configurations or structures exemplified in the above embodiments. As long as the above-described working and effect of the present invention can be obtained, the present invention can be freely changed according to specification, cost etc. of objects to which the present invention is applied.

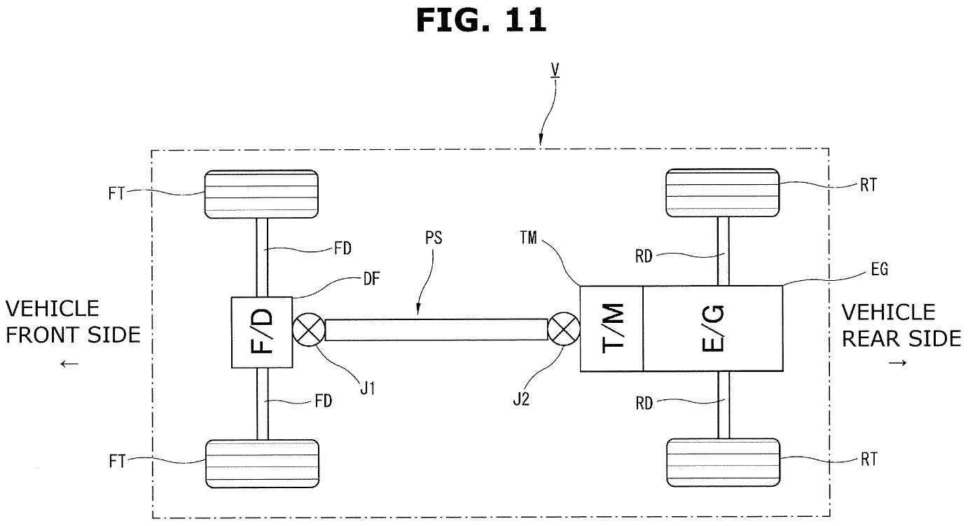

For instance, in each of the above embodiments, the case where the first power transmission device P1 is the transmission TM mounted on the vehicle and the second power transmission device P2 is the differential gear DF mounted on the vehicle is exemplified. However, as illustrated in FIG. 11, an opposite configuration to that of the above embodiments is possible. More specifically, the present invention can also be applied to, for instance, a vehicle having a rear-engine/all-wheel drive system and a vehicle having a drive system in which an engine EG and a transmission TM are mounted on a vehicle rear side and a driving force of the engine EG, output through the transmission TM, is transmitted to a differential gear DF mounted on a vehicle front side by a propeller shaft PS. That is, the first power transmission device P1 could be the differential gear DF of the vehicle V, and the second power transmission device P2 could be the transmission TM of the vehicle V.

According to this modified example, the first joint member J1 being relatively easy to bend is connected to the differential gear DF having a relatively large movement. Therefore, the movement of the differential gear DF is made to be absorbed by the first joint member J1 being easy to bend, thereby improving noise-vibration performance of the propeller shaft PS.

Further, in the case where the transmission TM is provided at the driving wheel (rear wheel) side, for instance, the first power transmission device P1 may be a driving source such as the engine, and the second power transmission device P2 may be the transmission TM. In addition, its opposite is also possible.

Additionally, the present invention can also be applied to a vehicle in which as the first power transmission device P1, an electric motor as a continuously variable reduction gear instead of the transmission TM is used.

Moreover, in each of the above embodiments, the case where the first collision load F1 and the second collision load F2 are set to be the same by setting the first biting length L1 and the second biting length L2 to be substantially the same and setting the first biting amount X1 and the second biting amount X2 to be substantially the same is exemplified. However, in addition to the relative relationship between the first collapse length S1 and the second collapse length S2, by making a difference between the first biting length L1 and the second biting length L2 and between the first biting amount X1 and the second biting amount X2, the first collision load F1 and the second collision load F2 are adjusted, and also by controlling an order of the collapse of the first joint member J1 and the second joint member J2, stabilization of the collision performance of the propeller shafts PS1, PS2 and PS3 can be improved.

1-16. (canceled)

17. A power transmission shaft transmitting power between a first power transmission device and a second power transmission device of a vehicle, comprising:
a tube formed into a tubular shape;
a first joint member having a first body portion and a first inserting portion,
wherein the first inserting portion is provided so that an outer peripheral portion of the first inserting portion is supported in a fixed state at an inner peripheral portion of a first end portion of the tube, which is one of a pair of end portions of the first end portion and a second end portion in a direction of a rotation axis of the tube, and so that when an input load of a first collision load or more acts on the first joint member, the fixed state between the first inserting portion and the tube is released and the first inserting portion can move from the first end portion toward the second end portion of the tube, and
wherein the first body portion is provided at an opposite side to the first inserting portion in the direction of the rotation axis with respect to the first end portion, and is connected to the first power transmission device through a first joint portion that can bend with respect to the direction of the rotation axis by a fact that a first bending load acts on the first joint portion; and
a second joint member having a second body portion and a second inserting portion,
wherein the second inserting portion is provided so that an outer peripheral portion of the second inserting portion is supported in a fixed state at an inner peripheral portion of the second end portion of the tube, and so that when an input load of a second collision load or more acts on the second joint member, the fixed state between the second inserting portion and the tube is released and the second inserting portion can move from the second end portion toward the first end portion of the tube, and
wherein the second body portion is provided at an opposite side to the second inserting portion in the direction of the rotation axis with respect to the second end portion, and is connected to the second power transmission device through a second joint portion for which a second bending load required when the second joint portion bends with respect to the direction of the rotation axis is set to be greater than the first bending load,
wherein the first joint member and the second joint member are formed so that when the input load acts on the first joint member and the second joint member, a first collapse length by which the first joint member is inserted into the inner peripheral portion of the tubeis longer than a second collapse length by which the second joint member is inserted into the inner peripheral portion of the tube, and
when the input load acts on the first joint member and the second joint member, a first time required for the first joint portion to come into contact with the first end portion of the tube is longer than a second time required for the second joint portion to come into contact with the second end portion of the tube.

18. The power transmission shaft as claimed in claim 17, wherein
the first joint member is connected to the first power transmission device through a constant-velocity joint.

19. The power transmission shaft as claimed in claim 18, wherein
the constant-velocity joint is fastened to the first power transmission device with bolts screwed from the tube side toward the first power transmission device side, and
the first collapse length is a distance from the first end portion of the tube to a head portion of the bolt.

20. The power transmission shaft as claimed in claim 17, wherein
the second joint member is connected to the second power transmission device through a rubber coupling, and
the second collapse length is a distance from the second end portion of the tube to a yoke connected to the rubber coupling.

21. The power transmission shaft as claimed in claim 17, wherein
a rotation axis of the first body portion is connected to the first power transmission device at a first bending angle with respect to the rotation axis of the tube,
a rotation axis of the second body portion is connected to the second power transmission device at a second bending angle with respect to the rotation axis of the tube, and
the first bending angle is smaller than the second bending angle.

22. The power transmission shaft as claimed in claim 17, wherein
the first joint member is connected to the first power transmission device through a cardan joint.

23. The power transmission shaft as claimed in claim 17, wherein
at least either one of the first inserting portion and the second inserting portion is connected to the inner peripheral portion of the tube through a serration.

24. The power transmission shaft as claimed in claim 17, wherein
at least either one of the first inserting portion and the second inserting portion is spline-connected to the inner peripheral portion of the tube.

25. The power transmission shaft as claimed in claim 17, wherein
the first power transmission device is a transmission of the vehicle,
the second power transmission device is a differential gear of the vehicle, and
the second joint member is formed by a rubber coupling.

26. The power transmission shaft as claimed in claim 17, wherein
the first power transmission device is a differential gear of the vehicle, and
the second power transmission device is a transmission of the vehicle.

27. The power transmission shaft as claimed in claim 17, wherein
the tube is made of a material formed by solidifying fiber with resin.

28. The power transmission shaft as claimed in claim 27, wherein
the first inserting portion has a first male spline portion engaging with a first female spline portion formed at the inner peripheral portion of the tube.

29. The power transmission shaft as claimed in claim 17, wherein
the tube is made of a metal material.

30. The power transmission shaft as claimed in claim 29, wherein
the second inserting portion has a second male spline portion engaging with a second female spline portion formed at the inner peripheral portion of the tube.
